(19) United States
(12) Patent Application Publication
(10) Pub. No.: US 2016/0303889 A1
(43) Pub. Date: Oct. 20, 2016

(54) SECURITY ELEMENT FOR A DOCUMENT OF VALUE AND/OR A SECURITY DOCUMENT

(71) Applicant: BUNDESDRUCKEREI GMBH, Berlin (DE)

(72) Inventors: Roland GUTMANN, FALKENSEE (DE); ALEXANDER MOMBREE, BERLIN (DE); MICHAEL KNEBEL, BERLIN (DE); CHRISTIAN KUNATH, BERLIN (DE); JENS EHREKE, BERLIN (DE)

(21) Appl. No.: 14/442,183

(22) PCT Filed: Nov. 15, 2013
(86) PCT No.: PCT/EP2013/073970

§ 371 Date: May 12, 2015

(30) Foreign Application Priority Data
Nov. 16, 2012 (DE) 10 2012 111 054.9

(51) Int. Cl. B42D 25/387; B42D 25/351; B42D 25/29

(52) U.S. Cl. CPC B42D 25/387; B42D 25/29; B42D 25/351

(57) ABSTRACT

A security element for a document of value is arranged on a transparent layer such as a film and includes a first periodic, optical structure, for example a grid of lines or a grid of points, which forms a first coating on a first side of the transparent layer, and a second periodic, optical structure, for example a grid of lines or a grid of points, which forms a second coating on the second side, which is disposed opposite the first side of the transparent layer. The first optical structure and the second optical structure overlap such that, as viewed by outside observer at a certain, predetermined viewing angle (α) or lighting angle, the structures show a color-changing effect.

The invention relates to a security element for a document of value and/or a security document, which is disposed on a transparent layer, for example, a film, wherein the security element has a first periodic, optical structure on the first side of the transparent layer and a second periodic, optical structure on the second side, which is disposed opposite the first side of the transparent layer. The invention further relates to a document of value and/or a security document comprising such a security element.

It is already known to provide documents of value and/or security documents, such as bank notes, chip cards, personal identification documents, passports, tickets, checks, and the like, with a transparent layer, for example, a film. Such a transparent film can contain, for example, a protective layer or a “see-through” element as the security element.

Security elements, which are high-quality elements that provide protection against copying, require either complex manufacturing or production process, such as, for example, the hologram, special pigments that are customized and often expensive, or other production-related aids for manufacturing and depicting variable information or effects. In particular, elements that provide protection against copying, which have a so-called tilt effect when viewed from different viewing angles, are known. When these elements are digitally reproduced, i.e., copied, said elements generate interference effects, which are also referred to as moiré patterns. Due to the higher resolution of digital scanners, however, reproduction results are continuously improving. As a result, the forgery-proofness of such security elements is limited. Furthermore, the manufacture of such elements is complex and cost-intensive, since a surface structure and imprinting and laser inscription are required.

Document EP 1 780 681 B1 makes known a security element for protection against copying, in which a substantially transparent substrate is provided, on the first side of which a halftone line structure having a first frequency is applied and on the second side of which a marking substance is applied. The marking substance has two different regions, wherein the first region contains a second halftone line structure having a second frequency, and the second region contains a third halftone line structure having a third frequency. The halftone line structures form a (partial) coating of the substrate. When the structures of the various halftone line structures, which have different frequencies, are placed on top of one another and looked through, a moiré pattern is observed. The solution according to the prior art is relatively complicated and includes only a few possibilities with respect to the image design. The verification of the security element is therefore difficult to carry out.

The problem addressed by the present invention is therefore that of creating a security element, which enables a copy-protection element to be manufactured in a low-cost and simple manner, and which also has greater protection against forgery. With regard to the document of value and/or security document, the problem is that of enabling this to be equipped with such a security element in a simple and low-cost manner.

The aforementioned problem is solved by a security element having the features of claim 1.

In particular, the security element has a first periodic, optical structure, for example a grid of lines or a grid of points, which forms a first coating on the first side of the transparent layer, and a second periodic, optical structure, for example a grid of lines or a grid of points, which forms a second coating on the second side, which is disposed opposite the first side of the transparent layer, wherein the first optical structure and the second optical structure are disposed to as to overlap such that, as viewed by outside observer at a certain, predetermined viewing angle relative to the surface of the transparent layer provided with the coatings or at the lighting angle of the light source used for verification, preferably a UV lamp, said structures show a color-changing effect, wherein the first coating has a first color and the second coating has at least one second color, which is different from the first color.

The security element according to the invention therefore advantageously provides a color-changing effect, which can be achieved in a low-cost and simple manner merely by using printing technology. Surface structuring is not necessary. The solution according to the invention makes use of the development of the technology such that it is now possible to achieve printing having highly exact register on different sides of a layer, for example, different sides of a film, by means of a suitable turning device. When the optical structures having different suitable colors that are visible to the observer (first color, second color) are printed on both sides, tilting the security element results in an increasing superposition of the colors or an increasing separation of the colors, which are disposed on the two sides of the transparent layer. As a result, a color-tone change (color change effect) is achieved that is dependent on the viewing angle or the lighting angle. The security element according to the invention is characterized by a high level of protection against forgery, due to the high requirements with respect to the accuracy of the register of the structures, and is suitable, in particular, for increasing the protection against forgery for ID1/ID3 plastic cards having a multilayer design. The security element according to the invention, as an element that provides protection against copying, has a high level of protection against forgery, in particular, when the color of the first coating and the color of the second coating are difficult to separate. Furthermore, the spatial separation of the colors of the first coating and the second coating results in a visible color change, which has a 3D effect (tilt effect) due to the structure of the security element. This tilt effect disappears after copying or scanning, since the levels of the first and the second coating are combined in one level.

It is also advantageous that the security element according to the invention can be easily verified without any further tools. Therefore, this is a security element for the first level of inspection.

The term “color” as used in the context of the present invention refers to the individual visual perception (surface color) of the security element, which is brought about by the reflection, absorption and/or emission of electromagnetic radiation on and/or in the security element and which is perceived by an observer upon viewing the security element from a certain angle. The color and, correspondingly, the color change of the optical structures can be defined, e.g., in the RGB, CMYK or HSV color spaces or in the CIELAB color space for surface colors or, for self-illuminating colors, in the CIE xy color space.

The color that is visible to the observer results from a combination of additive and/or subtractive color mixing of the color of the first layer and the color of the second layer, when the coating facing the observer is transparent. In this case, an additive color mixing results, in particular, for electromagnetic radiation of a certain wavelength range, which is emitted by the first coating and/or the second coating and also plays a role for the structural elements of the first optical structure and the second optical structure, which lie next to one another as observed from the particular viewing angle. Subtractive color mixing occurs with all classical colors (absorption colors) and is significant, in particular, for the structural elements having an absorption color, in each case, which are located on top of one another as observed from the particular viewing angle.

In another exemplary embodiment, the coating facing the observer is substantially not transparent, in particular not for UV light and/or visible light. In the case of intransparency to visible light, a color change effect can occur, at least as observed from a certain, predetermined viewing angle, in that the optical structure of the coating facing away from the observer at least partially disappears, as it were, underneath the optical structure of the coating facing the observer and, therefore, is not involved in the additive and/or subtractive color mixing. The color impression presented to the outside observer is therefore determined, substantially or completely, by the optical structure of the coating facing the observer. As an alternative, when the coating facing the observer is not transparent to UV light, the coating facing away from the observer can be excited by being illuminated from the side with a UV light source, which luminesces this coating, wherein this luminescence is perceived by the observer.

With respect to the transparency of the transparent layer disposed between the first optical structure and the second optical structure, it is necessary that the layer be transparent primarily for at least a sub-range of the visible wavelength range (380 nm to 780 nm) or the UV wavelength range. If a colorant (e.g., a pigment) is used for the first optical structure and/or the second optical structure, which is excited in a wavelength range outside of the visible wavelength range, it is necessary that the transparent layer also be transparent for this excitation wavelength range, which is preferably in the IR wavelength range or in the UV wavelength range.

In one exemplary embodiment, the transparent layer can be composed of two or more films or other layers. In this case, the films or other layers, which carry the first optical structure and the second optical structure, may need to be combined with highly exact register in the manufacture of the security element.

Reference is hereby also made to the difference from the halftone line structures disclosed in the prior art. With regard for the known security element, the only differences relate to the structure of the elements located on top of one another, which said elements generate the moiré pattern due to the frequency differences. A color change effect is not observed in this case. Nothing is found in document EP 1 780 681 B1 regarding the behavior of the security element in terms of the surface color.

The color change effect that is achieved becomes particularly clear to the observer when the first optical structure and the second optical structure are disposed relative to one another such that the elements of the first optical structure, e.g., the lines of the first optical structure, fully overlap the elements of the second optical structure, e.g., the lines of the second optical structure, as observed from a certain, predetermined angular range of viewing or illumination. This means that, in this angular range of viewing, the observer perceives a subtractive and/or additive color mixing of the colors of the two structures when the coating facing the observer is transparent, or, when the structure located closer to the observer completely or nearly completely absorbs the light used for the observation, the observer only perceives black elements of the first optical structure, while the second structure is no longer visible or is only partially visible. When the security element is tilted by a certain, predetermined angle out of this angular range of viewing, which depends on the thickness of the substrate and the undercut portion of the elements of the second optical structure relative to the elements of the first optical structure and can be adjusted, the second optical structure, which is located underneath, becomes visible to the observer without influence by the first optical structure, and therefore a color change takes place. At this tilt angle, the observer therefore perceives the color of the second optical structure.

The problem according to the invention is therefore also solved by a security element, which is disposed on a layer, which is transparent in the visible and UV wavelength ranges, for example, a film, wherein the security element has a first periodic, optical structure in the form of a grid of lines or a grid of points, which forms a first coating on the first side of the transparent layer, and a second periodic, optical structure in the form of a grid of lines or a grid of points, which forms a second coating on the second side, which is disposed opposite the first side of the transparent layer, wherein the first optical structure and the second optical structure are disposed to as to overlap such that these exhibit a color changing effect for an outside observer as viewed from a certain, predetermined viewing angle and under UV radiation, wherein the first coating contains a first color, which is not transparent for UV light, and pigments, which have a visible chromatic or achromatic surface color, and the second coating has at least one second color, which is different from the first color and contains luminescent pigments, wherein the first optical structure and the second optical structure are disposed relative to one another such that the elements of the first optical structure fully overlap the elements of the second optical structure as viewed from a certain, predetermined angular range of viewing or illumination.

It is advantageous when, in a preferred exemplary embodiment, the thickness of the transparent layer is in a range from 50 μm to 800 μm, preferably in the range from 70 μm to 250 μm, particularly preferably in the range from 100 μm to 150 μm. Since the tilting of the security element, which is necessary for the color change effect to occur, is dependent on the film thickness and the separation of the structural elements, e.g., the lines or the points, of the first optical structure and/or the second optical structure, this layer thickness is particularly well suited for the desired color change effect in combination with the usual line separations of a grid of lines or a grid of points.

In addition, the color change effect can be perceived particularly clearly by the observer when the first optical structure and the second optical structure are each designed as a grid of lines and when these grids of lines extend parallel to one another, at least in sections.

With regard to the perceptibility of the color change effect, it is furthermore advantageous when the separation between two adjacent structural elements, e.g., between two lines or two points, of the first optical structure and/or the second optical structure is 0.1-fold to 100-fold the thickness of the transparent layer, preferably 0.5-fold to 10-fold the thickness of the transparent layer, particularly preferably 0.5-fold to 3-fold the thickness of the transparent layer.

For the same reason, it is advantageous when the width of the structural elements, e.g., the width of the lines or the points of the first optical structure and/or the second optical structure is 0.1-fold to 100-fold the thickness of the transparent layer, preferably 0.5-fold to 10-fold the thickness of the transparent layer. For example, the width of the structural elements in a 100 μm-thick film, as the transparent layer, can be approximately 100 μm to 200 μm.

It is furthermore advantageous when the color separation of the first and/or the at least one second color between the state before and after the color change has a predetermined, sufficient value, preferably a value of ΔE>10. Complementary colors are best suited. When the colors are too similar, a color change (dE>10) cannot be detected. In this context, in another exemplary embodiment, the first color and the at least one second color can be designed as metameric colors, i.e., can achieve the same color impression before and/or after tilting. The difference between the colors can be detected only by disposing a filter between the security element and the observer, wherein the filter absorbs a predetermined wavelength range of the light and thereby makes the color change effect visible.

With regard to the detectability of the security feature or with regard to a reliable verification, it is advantageous when the first optical structure and/or the second optical structure, in totality, contain information in the form of an image and/or text and/or numbers. In particular, it is preferable for the information to be a personalization. The term “personalization” refers to information in the form of an image and/or text and/or numbers, which is unique or individualized, e.g., for the owner of the document of value and/or security document comprising the security element, or for the document of value or security document itself. Such a personalization can be, for example, a serial number, e.g., of a bank note, the picture or personal data, or the like, of the document owner, e.g., the owner of the passport, or a ticket number.

Particularly preferably, the first optical structure and/or the second optical structure are applied by means of a printing process, e.g., by means of offset lithography, letterpress printing, rotogravure, soft-ground etching, and/or digital printing, preferably by means of intaglio printing, by means of an offset printing process, or by means of an inkjet printing process. These printing processes are very low-cost alternatives to the manufacture of a security feature according to the invention. The inkjet printing process, in particular, is advantageous in terms of applying a personalization that changes with each security element. In this context, it is advantageous, for example, when either the first optical structure or the second optical structure is designed as a fixed grid of lines, for example. The respective other optical structure is then calculated and, correspondingly, is likewise printed as a grid of lines, for example, such that, of the at least two bits of information that are depicted at various tilt angles, one bit of information contains personalization, for example, the picture of the document owner.

In another exemplary embodiment, the first coating comprises pigments, which have a visible chromatic or achromatic surface color, and the second coating has luminescent pigments. Particularly preferably, the first coating additionally comprises luminescent pigments, which preferably emit electromagnetic radiation having a wavelength, which differs from the wavelength of the luminescent pigments of the second coating. A high level of protection against forgery can be achieved as a result. Within the scope of the present invention, the term “luminescence” is intended to refer to the phenomena of both fluorescence as well as phosphorescence.

The luminescent pigments, in particular fluorescent pigments, that are used are, for example, host lattices doped with rare earth metals, for example, with ytterbium, praseodymium, neodymium, europium, terbium, cerium, dysprosium, holmium, thulium, samarium-doped garnets, perovskites, oxides, sulfides, oxysulfides, phosphates, silicates, fluorides, nitrides or selenides, optionally with traces of heavy metals, such as, for example, silver, copper, manganese. Furthermore, organic luminescent materials can be used, for example, rhodamines, perylene dyes, isoindolinones, quinophthalones, oxazinones, coumarins, perinone dyes. The manufacture of such luminescent materials is known to a person skilled in the art and is described, for example, in the document WO 81/03508 A1. Commercially available luminescent pigments are, for example, LUMILUX CD 740 and LUMILUX Green CD 702 from Honeywell, Paliosecure Gelb from BASF, and Cartax from Clariant. Other luminescent materials can also be found in the “Phosphor Handbook”, 2^{nd} Edition, ISBN-13 978-0849335648, or the book “Optical Document Security”, 3^{rd} Edition, ISBN-13 978-1580532587.

The aforementioned problem is also solved by a document of value and/or a security document having an above-described security element. The advantages of the invention, which also apply similarly to the particular document of value and/or security document, have been presented above.

The security element can be obtained particularly easily when this security element is disposed in a window of the document of value and/or security document.

The invention is explained in the following on the basis of exemplary embodiments and with reference to the figures. All the features that are described and/or graphically depicted form the subject matter of the invention, either alone or in any combination, independently of their wording in the claims or their back-references.

Schematically in the drawings:

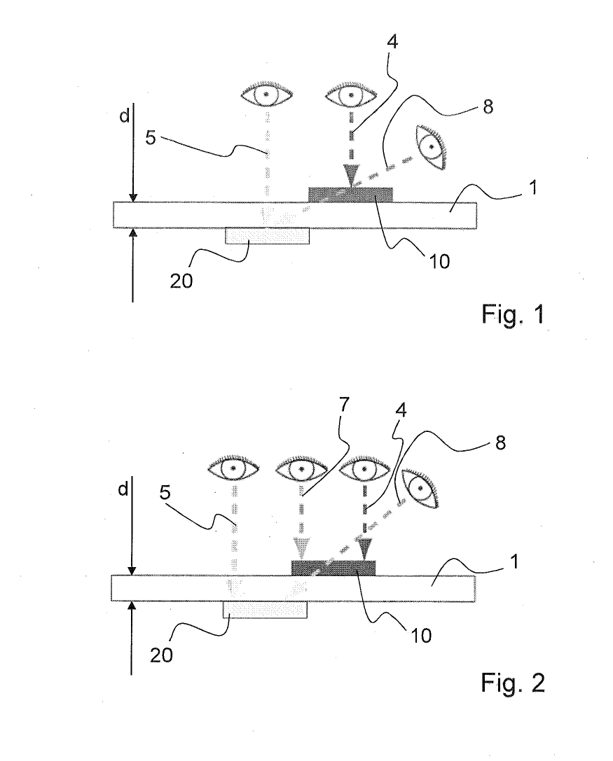

FIG. 1 shows a first exemplary embodiment of a security element according to the invention, in a view from the side,

FIG. 2 shows a second exemplary embodiment of a security element according to the invention, in a view from the side,

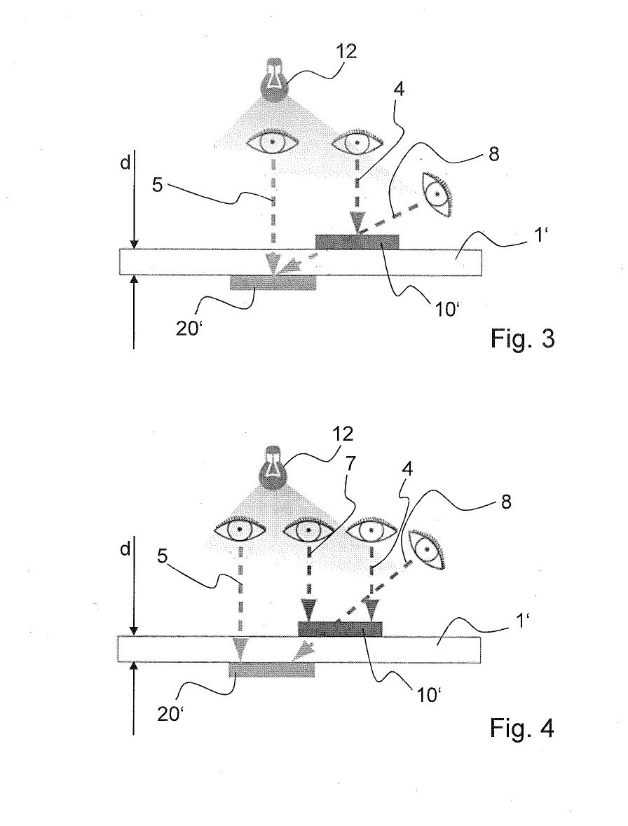

FIG. 3 shows a third exemplary embodiment of a security element according to the invention, in a view from the side,

FIG. 4 shows a fourth exemplary embodiment of a security element according to the invention, in a view from the side,

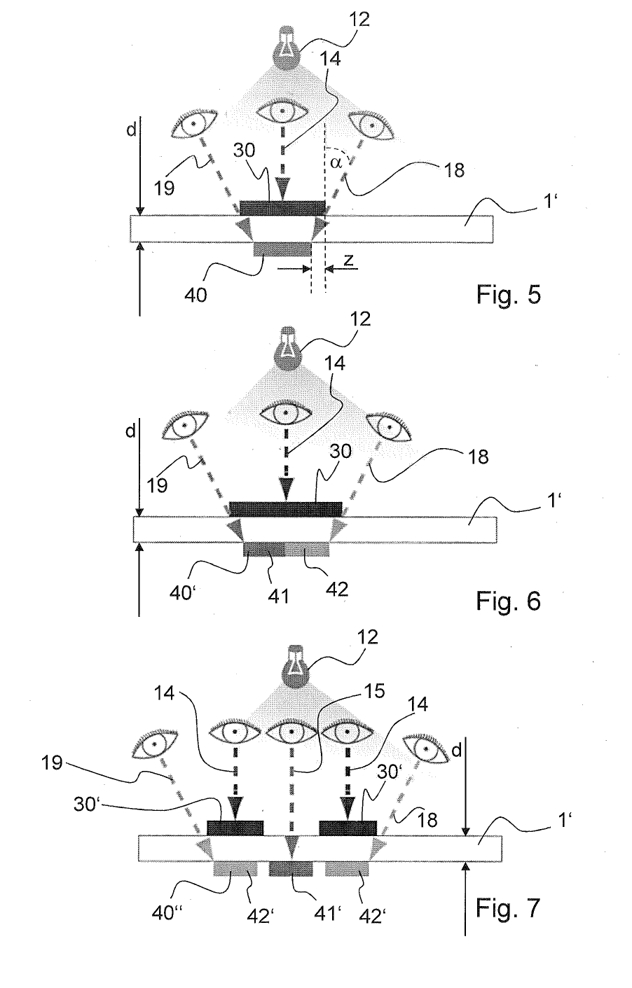

FIG. 5 shows a fifth exemplary embodiment of a security element according to the invention, in a view from the side,

FIG. 6 shows a sixth exemplary embodiment of a security element according to the invention, in a view from the side,

FIG. 7 shows a seventh exemplary embodiment of a security element according to the invention, in a view from the side,

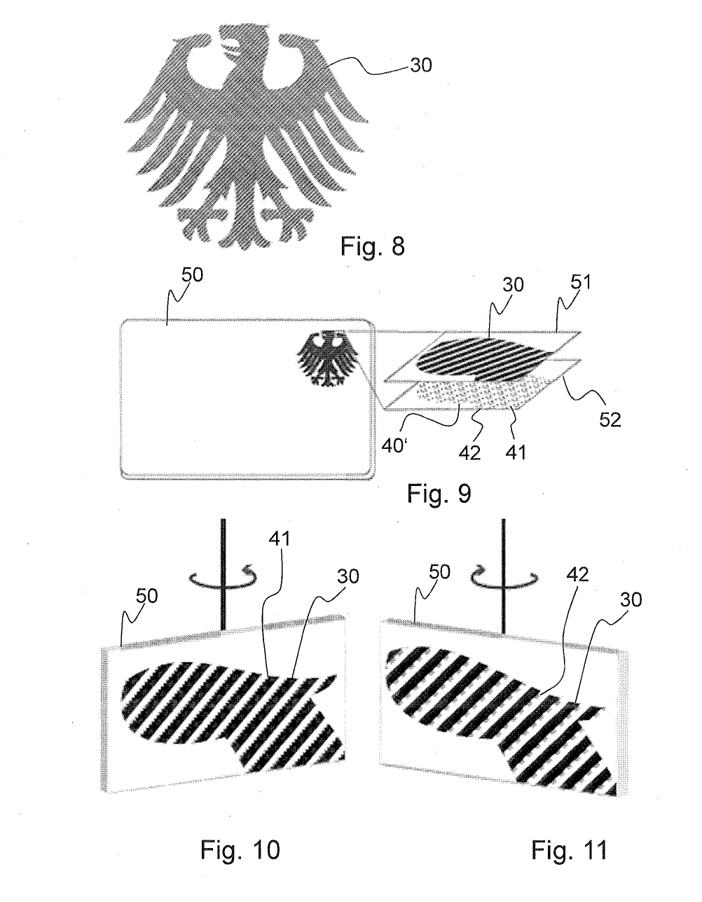

FIG. 8 shows an eighth exemplary embodiment of a security element according to the invention, in a view from the side,

FIG. 9 shows a document of value and/or a security document, according to the invention, comprising the security element according to FIG. 8, in a perspective view from the side,

FIG. 10 shows a cut-out of the document of value and/or security document according to FIG. 9, from a first viewing angle,

FIG. 11 shows a cut-out of the document of value and/or security document according to FIG. 9, from a second viewing angle, and

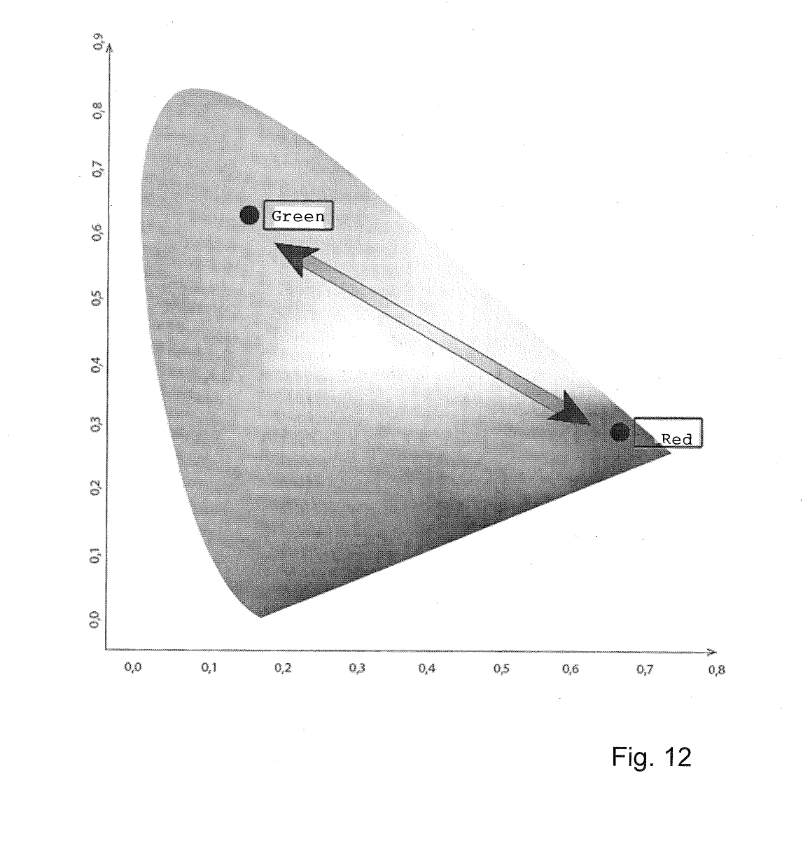

FIG. 12 shows the CIE standard colorimetric system with a depiction of the colors used in the color change effect for the exemplary embodiments of security elements according to the invention, which are explained with reference to the aforementioned figures.

FIG. 1 shows a film 1, which is transparent for visible light and comprises a first grid of lines 10, as the first optical structure, on the top side, and a second grid of lines 20, as the second optical structure, on the underside of the film 1. The film 1 comprises, for example, PC, PET, PETG, PVC, PE, PA, and has a thickness d in the range from 50 μm to 300 μm. If the film 1 is made of PC, this film preferably has a thickness in the range from 100 μm to 150 μm.

The first grid of lines 10 and the second grid of lines 20 are depicted in a simplified manner in each of FIGS. 1 to 7 by means of a single line or two or three lines, each of which is shown from the side, perpendicular to the extension direction. In this case and in the following exemplary embodiments, the relevant optical structure has a grid of lines, i.e., a plurality of parallel lines. As an alternative, the exemplary embodiments that are shown can also be embodied as grids of points. In other exemplary embodiments, grids of squares, triangles, hexagons, rectangles, and/or similar geometric forms can be used as periodic, optical structures.

In the first exemplary embodiment, which is shown in FIG. 1, the lines of the first grid of lines 10 and those of the second grid of lines 20 are disposed so as to not lie directly on top of one another upon perpendicular viewing. This means that the open space between adjacent lines of the first grid of lines 10 is at least as large or larger than the width of the lines of the second grid of lines 20. Due to this arrangement, the lines of the first grid of lines 10 and of the second grid of lines 20 are each seen in their own, separate colors as viewed from a direction perpendicular to the surface of the film 1 (cf. lines of view 4, 5). To the observer, the lines of the first grid of lines 10 appear, for example, as lines having a red color and the lines of the second grid of lines 20 appear—through the film 1—as lines having a yellow color. From a direction that is perpendicular to the surface of the film 1, the observer therefore sees a structure containing red and yellow lines lying next to one another.

However, as soon as the security element is tilted relative to the observer, the light beam 1 passes through the lines of the first grid of lines 10, in a range that is dependent on the tilt angle, and reaches the lines of the second grid of lines 20 (see line of view 8). The colors of the optical structures lying on top of one another therefore affect one another in this range, such that, according to the laws of subtractive color mixing, the observer sees regions having an orange color as viewed from an angle. This color-tone change from red or yellow to orange produces the above-described color change effect.

The exemplary embodiment shown in FIG. 2 corresponds to the exemplary embodiment illustrated in FIG. 1, with the difference that the grids of lines 10 and 20 are partially disposed on top of one another also when viewed perpendicularly from above, i.e., perpendicularly to the surface of the film 1, such that the observer also sees regions that have an orange color as viewed from the perpendicular direction (see line of view 7).

The grids of lines 10, 20 of the exemplary embodiments depicted in FIGS. 1 and 2 were respectively printed on the two sides on the film 1, e.g., by means of offset or inkjet printing. The coloration of the lines of the grids of lines is achieved, in each case, by means of suitable pigments contained in the particular ink. The colors of the lines of the exemplary embodiments according to FIGS. 1 and 2 are generated via illumination with visible light.

Exemplary embodiments are depicted in FIGS. 3 and 4 that are very similar to FIGS. 1 and 2. The third exemplary embodiment, which is shown in FIG. 3, is analogous to the first exemplary embodiment according to FIG. 1 and the fourth exemplary embodiment according to FIG. 4 is analogous to the second exemplary embodiment according to FIG. 2. In contrast to the inks used for the grids of lines 10, 20 according to FIGS. 1 and 2, the inks used for the first grid of lines 10′ and the second grid of lines 20′ are pigments that emit electromagnetic radiation in the visible wavelength range when irradiated with light from the UV wavelength range by means of a UV lamp 12.

The pigments used in the first grid of lines 10′ in FIG. 3 emit light, for example, from the visible red wavelength range and the pigments used in the second grid of lines 20′ emit light from the visible green wavelength range. Therefore, as viewed from a direction perpendicular to the surface of the film 1 of the third exemplary embodiment of a security element according to the invention, the observer sees red and green lines, which are disposed so as to be offset relative to one another (cf. lines of view 4, 5). As soon as the observer tilts the security element toward the perpendicular direction, parts of the grids of lines 10′ and 20′ are located one above the other and the observer sees dark brown lines in certain regions (cf. line of view 8).

Similarly to FIG. 2, the grids of lines 10′, 20′ in FIG. 4 are located partially on top of one another. As viewed perpendicularly from above (see line of view 7), regions are therefore also already present, which appear to be brown due to the first optical structure emitting red and the second optical structure emitting green.

FIGS. 5 to 7 show the fifth to seventh exemplary embodiments of grids of lines, which are disposed directly above one another, either entirely or partially. The upper, first grid of lines 30, 30′, which faces the observer, absorbs all the UV light received from the UV lamp 12 and does not emit any electromagnetic radiation in the visible wavelength range, and therefore the observer sees black lines. The UV lamp 12 is preferably disposed behind the eye of the observer in this case, which differs from the depiction. This also applies for FIGS. 3 and 4.

A second grid of lines 40, which is located directly underneath the first grid of lines 30, is disposed, in the fifth and sixth exemplary embodiments, such that the lines of the second grid of lines 40 and 40′ are completely covered by the lines of the first grid of lines 30 in a state in which the observer looks perpendicularly onto the surface of the substrate 1 (see line of view 14 in each case). From this angle and in a small region about this angle, the observer therefore sees only black lines.

From a certain, predetermined angle α relative to the normal line, which results from the thickness d of the film 1′ and the length of the “undercut portion” z of the second grid of lines 40 and 40′ relative to the first grid of lines 30 according to

α=arctan(z/d) (1)

the observer can look past the lines of the first grid of lines 30, on the side (see lines of view 18, 19), and thereby see the grid of lines 40 located thereunder, which emits light in the red wavelength range, for example, under UV radiation. As the tilt having an angle>α increases, the observer therefore sees an increasing portion of red color, i.e., in this exemplary embodiment, the color change takes place at an angle α. For example, the thickness of the film 1′ is d=100 μm and the undercut portion is z=100 μm, thereby resulting in an angle of α=45°. In a first alternative exemplary embodiment, d=100 μm, z=30 μm and, therefore, α=16.7°, and in a second exemplary embodiment, d=100 μm, z=58 μm and, therefore, α=30.1°.

Depending on the materials selected for the film 1′, it is necessary to also account for Snell's law, i.e., the law of refraction, in the calculation of the angle (critical angle) at which the color change effect occurs; Snell's law states that a light ray bends relative to the normal in media that are optically denser than air (i.e., having an index of refraction n>1), according to the formula

sin α1/sin α2=n2/n1

wherein n1 is the index of refraction for air, n2 is the index of refraction of the material of the film (n2=1.58 in the case of PC used as the material of the film 1′), α1 is the angle of the line of view relative to the normal in air, and α2 is the angle of the line of view relative to the normal in the material of the film.

The parameters mentioned above with respect to the fifth exemplary embodiment can also be provided, similarly, for the exemplary embodiment shown in FIG. 6, wherein the second grid of lines 40′ in this exemplary embodiment is a grid of lines composed of adjacently disposed lines having pigments, which emit light having different colors under UV radiation. In FIG. 6, the lines of the second grid of lines 40′ are composed, as an example, of a first line 41, which emits light from the red wavelength range, and a second line 42, which emits light from the green wavelength range. Due to the combined nature of the second grid of lines 40′, two color change effects are observed in this exemplary embodiment. If the observer views the security element from a first, slanted direction (see line of view 18), he looks past the first grid of lines 30 and onto the second lines 42 of the second grid of lines 40′ and sees a green color. If the observer tilts the security element in the opposite direction proceeding from the vertical direction of view, the observer sees the first lines 41 of the second grid of lines 40′, which emit light from the red wavelength range, at a tilt about a certain, predetermined angle.

The exemplary embodiment shown in FIG. 7 can be viewed as a combination of the exemplary embodiments depicted in FIG. 3 and FIG. 5. As viewed from the perpendicular direction (see line of view 15), first lines 41′ of the second grid of lines 40″ are disposed in the space between two lines of the first grid of lines 30′ and can therefore be seen when viewed perpendicularly from above (see line of view 17′). The observer therefore sees black and red lines under UV radiation from the perpendicular direction. Similarly to the exemplary embodiment shown in FIG. 5, the second lines 42′ of the second grid of lines 40″ are disposed underneath the lines of the first grid of lines 30′ and are therefore not visible until the security element is tilted relative to the perpendicular by a certain, predetermined angle (see lines of view 18 and 19). After the tilt about the necessary angle (cf. formula (1), above), the observer therefore sees, under UV radiation, a grid of lines 42′ having lines, which emit in the green wavelength range and a grid of lines 41′ having lines, which emit in the red wavelength range, as well as the black lines of the first grid of lines 30′.

The films 1′ of the exemplary embodiments 3 to 7 must also be transparent for the UV wavelength range in order to permit an excitation of the pigments of the lines of the second grid of lines 20′, 40, 40′, 40″. The following film materials PC, PET, PETG, PVC, PE and PA, preferably PC, are preferably suitable for this.

In another exemplary embodiment, rather than changing the position of the observer (cf. lines of view 14, 15, 18 and 19) of the exemplary embodiments according to FIGS. 5 to 7, it is possible to change the position of the light source (UV lamp 12) in an analogous manner, while the position of the observer remains unchanged. In this case, the first grid of lines 30, 30′ comprises a color layer, which absorbs UV and is transparent for visible light. The same effect is achieved for the observer with the second grid of lines 40, 40′ and 40″, which emit under UV radiation, as with the variants depicted in FIGS. 5 to 7.

The exemplary embodiments according to FIGS. 3 to 7 are also produced using two-sided offset printing or inkjet printing on the film 1′. The inks contain pigments, which emit light in the visible wavelength range when irradiated in the UV wavelength range.

FIG. 8 shows an eighth exemplary embodiment of a security element according to the invention, in the form of an eagle, which is composed of two grids of lines 30, 40′ in a manner analogous to the exemplary embodiment shown in FIG. 6, wherein the security element is disposed on a document of value and/or a security document in the form of a personal identification card 50 (see FIG. 9). The first grid of lines 30, which is composed of a plurality of black lines, is provided on the side 51 of the identification card 50 facing the observer, which is shown in FIGS. 8 to 11. The second grid of lines 40′ is disposed on the side 52 of the identification card 50 facing away from the observer, said second grid of lines being composed of a plurality of first lines 41 (e.g., red lines, shown here as dotted lines) and second lines 42 (e.g., green lines, shown here as dashed lines), wherein a first line 41 is located next to a second line 42 in each case.

In the view depicted in FIG. 8, i.e., a view by a person perpendicularly from above (cf. line of view 14 in FIG. 6), all that is seen is a gray eagle, which is formed of the first grid of lines 30 having black lines and white intermediate spaces.

After the identification card 50 is tilted by an angle of, e.g., at least 45° in the clockwise direction (see FIG. 10 and line of view 19 in FIG. 6), the observer sees a dark red eagle, for example, since not only can he see the black lines of the first grid of lines 30, but also the first (e.g., red) lines 41 of the second grid of lines 40′. Therefore, the observer sees a color change effect from black to red over the course of the tilting of the identification card 50.

In an analogous manner, when the identification card 50 is tilted by an angle of at least 45°, for example, in the counterclockwise direction (see FIG. 11 and line of view 18 in FIG. 6), a second color change effect from black to green takes place, since the second (e.g., green) lines 42 become visible in addition to the black lines of the first grid of lines 30 at a certain, predetermined angle.

The colors that are suitable for the above-described exemplary embodiments are depicted in FIG. 12 on the basis of the CIE color system, which is known per se.

The first dot, “red”, is the color of the first grid of lines 10, 10′ of the first to fourth exemplary embodiments (FIGS. 1 to 4), the color of the lines of the second grid of lines 40 of the fifth exemplary embodiment (FIG. 5), and the color of the first lines 41, 41′ of the second grid of lines 40′, 40″ of the sixth to eighth exemplary embodiment (FIGS. 6 to 11) for a security element according to the invention. The “red” dot has approximately the following portions of the primary colors red, green, blue: x=0.66 (red), y=0.3 (green), z=0.04 (blue).

The second dot, “green”, is the color of the second grid of lines 20′ of the third and fourth exemplary embodiment (FIGS. 3 to 4) and the color of the second lines 42, 42′ of the second grid of lines 40′, 40″ of the sixth to eighth exemplary embodiment (FIGS. 6 to 11) for a security element according to the invention. The “green” dot has approximately the following portions of the primary colors red, green, blue: x=0.15 (red), y=0.64 (green), z=0.21 (blue).

In another exemplary embodiment, the first coating and/or the second coating could be additionally provided with pigments, which emit, reflect, or absorb electromagnetic radiation in the wavelength range that is not visible to the human eye. These pigments contain an additional security element, which is preferably machine-readable.

The above-presented exemplary embodiments show a security element, which can be manufactured in a simple and low-cost manner, and which offers a high level of protection against forgery by copying, in particular, due to the three-dimensional nature thereof.

### LIST OF REFERENCE SIGNS

1, 1′ film
4, 5, 7, 8 lines of view
10, 30, 30′ first grid of lines
12 UV lamp
14, 15, 18, 19 lines of view
20, 40, 40′, 40″ second grid of lines
41, 41′ first lines of the second grid of lines 40′ and 40″, respectively
42, 42′ second lines of the second grid of lines 40′ and 40″, respectively
50 identification card
51 the side of the identification card 50 facing the observer
52 the side of the identification card 50 facing away from the observer
d thickness of the film 1, 1′
z undercut portion of the second grid of lines relative to the first grid of lines
α angle relative to the normal on the surface of the film 1′

1. (canceled)

2. (canceled)

3. A security element for a document of value, a security document, or both, comprising:
a layer that is transparent in the visible and UV wavelength ranges;
a first periodic, optical structure in the form of a grid of lines or a grid of points, which forms a first coating on a first side of the transparent layer; and
a second periodic, optical structure in the form of a grid of lines or a grid of points, which forms a second coating on a second side of the transparent layer, which is disposed opposite the first side of the transparent layer;
wherein the first optical structure and the second optical structure overlap and exhibit a color changing effect for an outside observer as viewed from a certain, predetermined viewing angle (α) and under UV radiation;
wherein the first coating contains a first color, which is not transparent for UV light, and pigments, which have a visible chromatic or achromatic surface color, and the second coating has at least one second color, which is different from the first color and contains luminescent pigments; and
wherein the first optical structure and the second optical structure are disposed relative to one another such that the elements of the first optical structure fully overlap the elements of the second optical structure as viewed from a certain, predetermined angular range of viewing or illumination.

4. The security element according to claim 3, wherein a thickness (d) of the transparent layer is in a range from 50 μm to 800 μm.

5. The security element according to claim 3, wherein the grid of lines of the first optical structure extends parallel to the grid of lines of the second optical structure, at least in sections.

6. The security element according to claim 3, wherein a separation between two adjacent structural elements of the first optical structure, the second optical structure or both is 0.1-fold to 100-fold a thickness of the transparent layer.

7. The security element according claim 3, wherein a width of the elements of the first optical structure, the second optical structure or both is 0.1-fold to 100-fold a thickness of the transparent layer.

8. The security element according to claim 3, wherein the first optical structure, the second optical structure, or both, in totality, contain information in the form of an image, text, numbers or a combination the image, the text and the numbers.

9. The security element according to claim 3, wherein the first optical structure, the second optical structure or both are applied by a printing process.

10. (canceled)

11. The security element according to claim 3 wherein the first coating additionally comprises luminescent pigments, which preferably emit electromagnetic radiation having a wavelength, which differs from a wavelength of the luminescent pigments of the second coating.

12. A document of value, a security document or both comprising a security element according to claim 3.

13. The document of value, a security document or both, according to claim 12, wherein the security element is disposed in a window of the document of value, the security document or both.

14. The security element according to claim 4, wherein the thickness (d) of the transparent layer is in a range of from 70 μm to 250 μm.

15. The security element according to claim 4, wherein the thickness (d) of the transparent layer is in a range of from 100 μm to 150 μm.

16. The security element according to claim 6, wherein the separation between two adjacent structural elements of the first optical structure, the second optical structure or both is 0.5-fold to 10-fold the thickness of the transparent layer.

17. The security element according to claim 16, wherein the separation between two adjacent structural elements of the first optical structure, the second optical structure or both is 0.5-fold to 3-fold the thickness of the transparent layer.

18. The security element according claim 7, wherein the width of the elements of the first optical structure, the second optical structure or both is 0.5-fold to 10-fold the thickness of the transparent layer.

19. The security element according to claim 9, wherein the printing process is selected from the group of printing processes consisting of offset lithography, letterpress printing, rotogravure, soft-ground etching and digital printing.

20. The security element according to claim 19, wherein the printing process is selected from the group of printing processes consisting of intaglio printing, an offset printing process and an inkjet printing process.
